(19) United States
(12) Patent Application Publication
(10) Pub. No.: US 2004/0201958 A1
(43) Pub. Date: Oct. 14, 2004

(54) System and method for cooling an electronic device

(76) Inventor: Jeffrey A. Lev, Cypress, TX (US)

Correspondence Address: HEWLETT PACKARD DEVELOPMENT COMPANY, Intellectual Property Administration, P.O. Box 272400, Fort Collins, CO, 80527-2400, US

(21) Appl. No.: 10/412,980

(22) Filed: Apr. 14, 2003

(51) Int. Cl. G06F 1/20

(52) U.S. Cl. 361/687

(57) ABSTRACT

A system comprises an electronic device having a component to be cooled. The electronic device has at least one heat pipe coupled to the component. A heat exchanger system is coupled to the at least one heat pipe. Also, the electronic device comprises a fan having a plurality of exhaust outlets oriented to exhaust air toward the heat exchanger system.

### BACKGROUND

A variety of cooling systems are utilized with electronic devices, such as computers. Such cooling systems can, for example, incorporate one or more fans that circulate air through at least portions of the device chassis to remove heat generated by electronic components. Sometimes, heat sinks are combined with components, such as processors, that produce substantial amounts of heat. The heat sinks help transfer heat from the component to heat dissipation features, such as fins. A fan is often utilized to direct an airflow across the heat sink to facilitate dissipation of the heat energy. However, as the capabilities of certain electric components have been increased, the heat output by such devices also has increased, rendering dissipation of the excess heat more difficult. For example, central processing units (CPUs), e.g., microprocessors, have increased in capacity and speed, leading to greater output of heat and increased requirements for heat removal.

### SUMMARY

In an embodiment of the present invention, a system comprises an electronic device having a component and at least one heat pipe coupled to the component. The electronic device further comprises a plurality of heat exchangers coupled to the at least one heat pipe and a fan having a plurality of exhaust ports oriented toward the plurality of heat exchangers.

Another embodiment relates to a cooling system. The cooling system comprises a fan having a plurality of exhaust ports and at least one heat exchanger disposed along the plurality of exhaust ports. The system further comprises a heat transfer member coupled to the at least one heat exchanger along the plurality of exhaust ports.

Another embodiment relates to a method for dissipating heat. The method comprises connecting a component of an electronic device to at least one heat pipe and coupling the at least one heat pipe to a heat exchanger system. The method further comprises positioning the heat exchanger system adjacent a plurality of fan exhaust outlets.

### BRIEF DESCRIPTION OF THE DRAWINGS

Certain embodiments of the invention will hereafter be described with reference to the accompanying drawings, wherein like reference numerals denote like elements, and:

FIG. 1 is a perspective view of an implementation of an electronic device according to an embodiment of the present invention;

FIG. 2 is a top perspective view of an embodiment of a cooling system for use with an electronic device such as the device illustrated in FIG. 1;

FIG. 3 is a bottom perspective view of the cooling system illustrated in FIG. 2;

FIG. 4 is a perspective view of an embodiment of a fan used with the cooling system illustrated in FIG. 2;

FIG. 5 is a perspective view of the fan illustrated in FIG. 4 taken from a different orientation;

FIG. 6 is a top perspective view of another embodiment of a cooling system for use with a device, such as the device illustrated in FIG. 1; and

FIG. 7 is a bottom perspective view of cooling system illustrated in FIG. 6.

### DETAILED DESCRIPTION

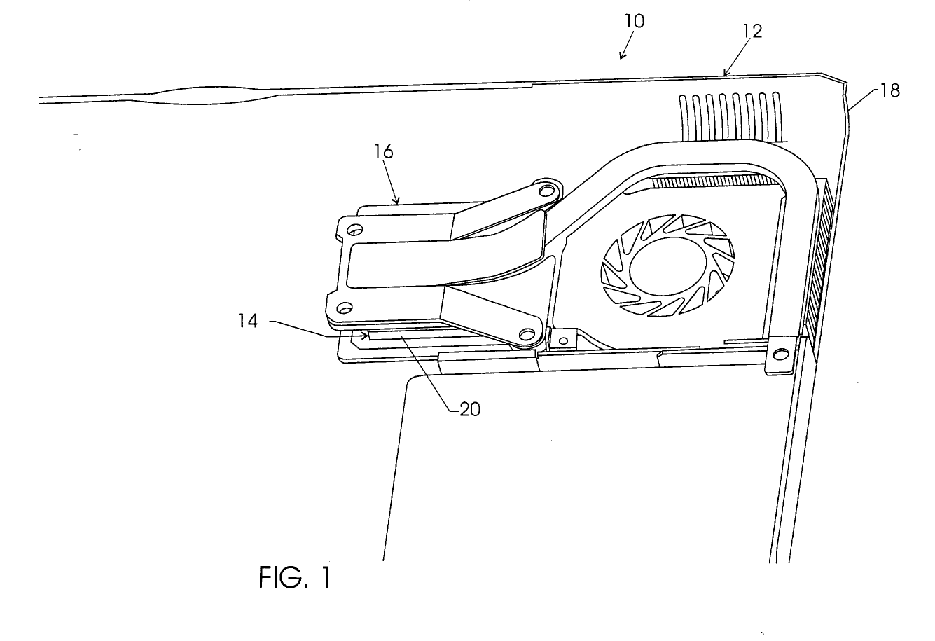

Referring generally to FIG. 1, a system 10 to promote cooling of a desired component is illustrated in accordance with an embodiment of the present invention. In the embodiment illustrated, system 10 comprises an electronic device 12 having at least one component 14 that may be cooled by a cooling system 16.

By way of example, electronic device 12 may comprise a variety of electronic devices, including desktop computers, servers, workstations and portable computers, such as notebook computers. The electronic device has a housing 18, such as a notebook computer housing 18. Computer housing 18 encloses or at least partially encloses component 14, and cooling system 16 is designed to facilitate the removal of heat from component 14. Component 14 may comprise a variety of heat generating or heated components. For example, the component 14 illustrated in FIG. 1 comprises a central processing unit (CPU) 20, such as a microprocessor. As illustrated, cooling system 16 may be positioned to abut against or to lie proximate CPU 20 so heat is transferred away from the component.

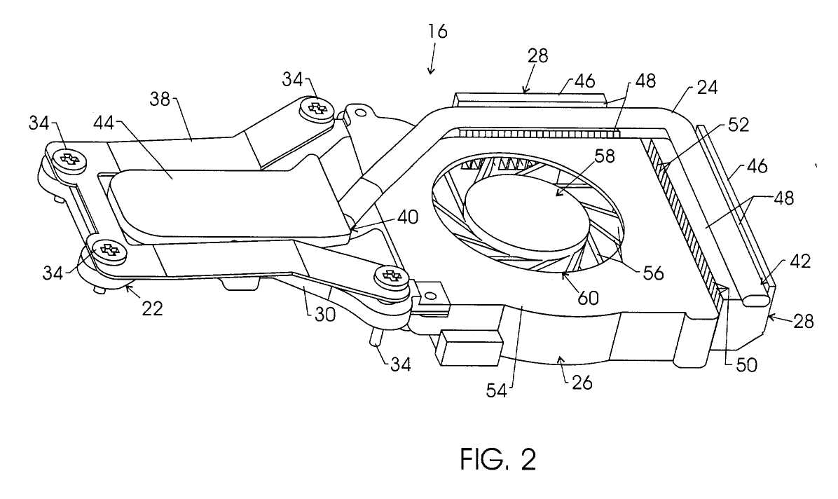

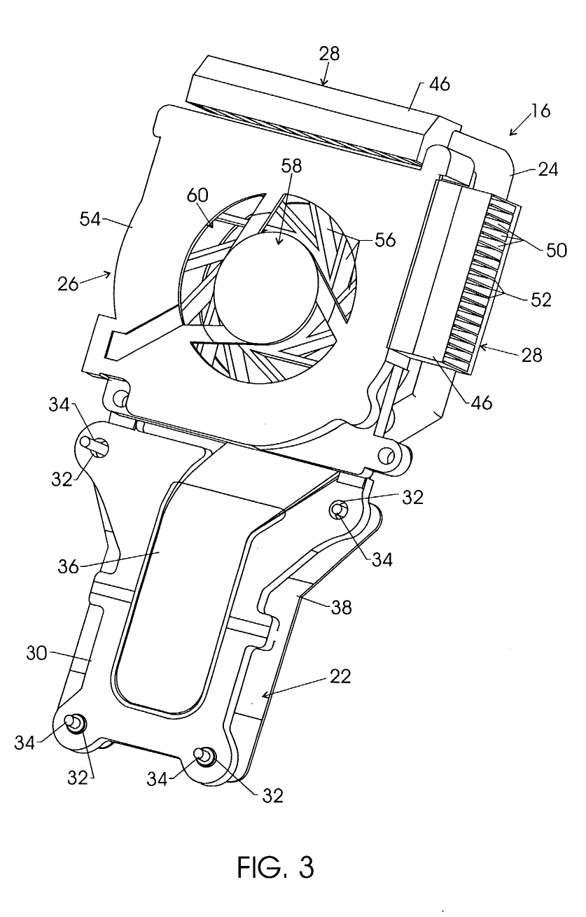

An embodiment of cooling system 16 is illustrated in FIGS. 2 and 3. In this embodiment, cooling system 16 comprises a heat sink 22, a heat transfer member, such as a heat pipe 24, a fan 26 and at least one heat exchanger 28. For example, a pair of heat exchangers 28 are illustrated along the sides of fan 26. Generally, heat from component 14 is transferred to heat sink 22, and heat pipe 24 provides a relatively efficient transfer of heat from heat sink 22 to the at least one heat exchanger 28. Fan 26 directs a flow of air past heat exchanger 28 to carry heat away from the system.

In the embodiment illustrated, heat sink 22 comprises a frame 30 having a plurality of openings 32. Openings 32 are sized to receive fasteners 34, such as screws, therethrough. Fasteners 34 may be engaged with computer housing 18 or other components within computer housing 18 to secure heat sink 22 against component 14.

Heat sink 22 may further comprise a contact pad 36 formed as a unitary component with frame 30 or as a separate component. In this design, contact pad 36 is designed for contact with component 14 either directly or through other conductive materials. Also, a mounting bracket 38 may be utilized in conjunction with frame 30 to fasten heat sink 22 proximate component 14. In this embodiment, mounting bracket 38 comprises a sheet of material, such as a sheet of metal material. Each of the fasteners 34 extends through mounting bracket 38 and the appropriate opening 32 for engagement with electronic device 12. The configuration and materials utilized for mounting bracket 38, frame 30 and contact pad 36 may vary for different devices, components and applications.

Heat pipe 24 is secured to heat sink 22 and extends therefrom. A first end 40 of the heat pipe 24 is secured to heat sink 22 in a manner that facilitates the transfer of heat along heat pipe 24 towards a second or distal end 42. The first end 40 may be coupled to heat sink 22 by an adhesive or other fastening mechanism. For example, a heat sink cover portion 44 may be used to trap the first end 40 between frame 30 and/or contact pad 36 and the cover portion 44. The cover portion 44 is held against frame 30 by, for example, mounting bracket 38.

Generally, heat pipe 24 is routed along the at least one heat exchanger 28. For example, in the illustrated embodiment, heat pipe 24 is disposed against a pair of heat exchangers 28 to facilitate the transfer of heat to both heat exchangers. Depending on the number of exhaust outlets in fan 26, additional heat exchangers also can be incorporated into the design with heat pipe 24 routed through the heat exchangers.

Each of the heat exchangers 28 comprises a conductive frame 46 having a heat transfer surface 48 in contact with heat pipe 24. Additionally, each heat exchanger 28 has heat dissipation surfaces 50 to enhance the transfer of heat away from heat pipe 24 as air is moved across heat dissipation surfaces 50 via fan 26. In the embodiment illustrated, heat dissipation surfaces 50 are disposed on a plurality of heat dissipation fins 52 that may be generally aligned with the air flow exhausted from fan 26.

Fan 26 may comprise a blower fan defined by a housing 54. Within housing 54, fan blades 56 are rotated by a motor 58 to draw air inwardly through at least one air inlet 60. The air is exhausted or expelled along heat dissipation surfaces 50 to remove the heat transferred to heat exchangers 28 from component 14 via heat sink 22 and heat pipe 24.

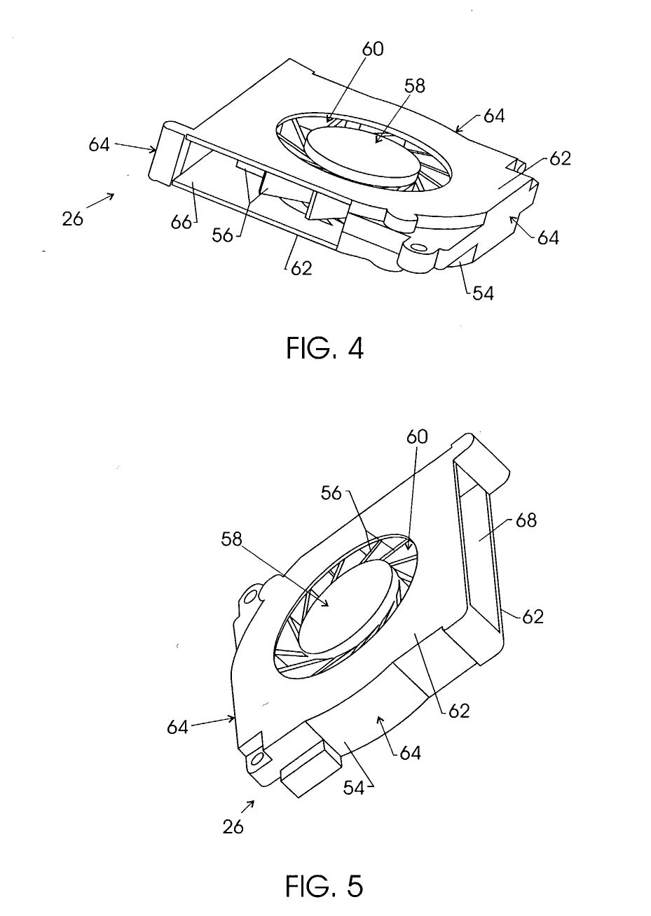

Although fan 26 may have a variety of forms and sizes, one example has housing 54 in a generally flat configuration with a pair of generally parallel walls 62 through which air inlets 60 are formed, as illustrated in FIGS. 4 and 5. Walls 62 are separated by side wall 64 having a first air outlet 66 (see FIG. 4) and a second air outlet 68, (see FIG. 5). Air is exhausted through air outlets 66 and 68 to heat exchangers 28. Thus, while fan 26 is operating, air is drawn in through at least one of the air inlets 60 and exhausted through air outlets 66 and 68 to heat exchangers 28. Depending on the specific application and the number of heat exchangers 28, the number of air outlets formed in side wall 64 may vary. Additionally, the type of fan 26 and the configuration of fan 26 can be changed to accommodate different applications, different sizes and different electronic devices 12.

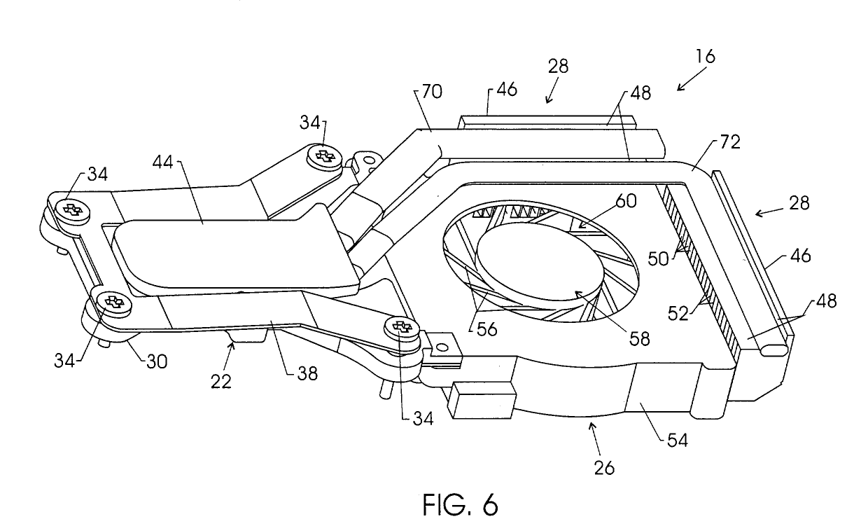

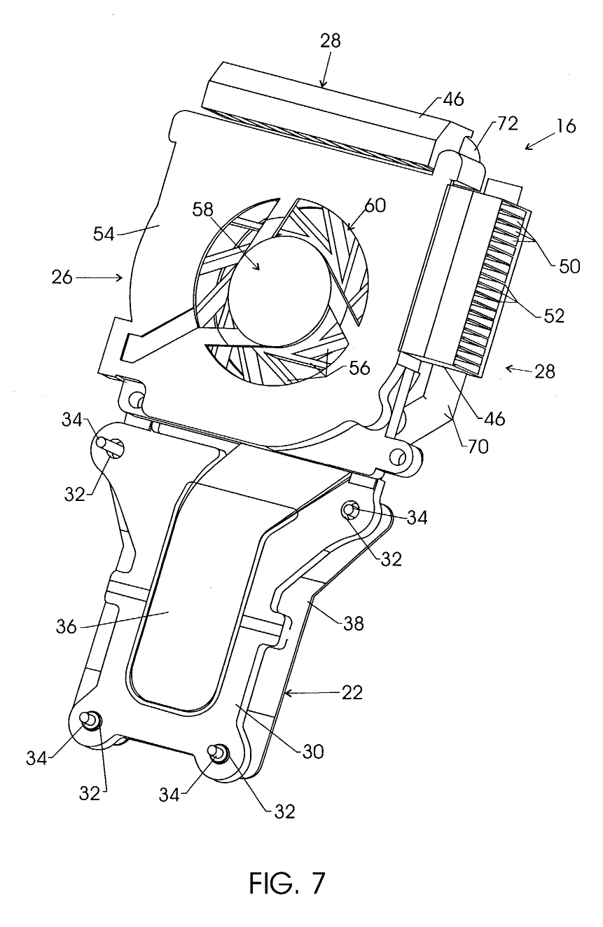

Another embodiment of cooling system 16 is illustrated in FIGS. 6 and 7. In this embodiment, a plurality of heat pipes, e.g. heat pipes 70 and 72, are coupled to heat sink 22 as described above with reference to the embodiment illustrated in FIGS. 2 and 3. The heat pipes 70 and 72 are routed to separate heat exchangers or heat exchanger sections. For example, heat pipe 70 may be coupled to the heat exchanger 28 dispose adjacent air outlet 66, and heat pipe 72 may be coupled to the heat exchanger 28 disposed adjacent air outlet 68.

It should be noted that the present invention is not limited to the specific forms illustrated. For example, single or multiple heat pipes may be coupled to one, two or more heat exchangers; a plurality of heat pipes may be routed to each heat exchanger; the heat pipes potentially can be replaced or supplemented with other heat transfer members; the design and configuration of the heat sink, the fan and the heat exchangers can be changed according to the desired application; the component from which heat is removed can be any of a variety of single or multiple components that generate heat, are heated or otherwise require cooling; and the cooling system may be utilized in a variety of devices.

What is claimed is:

1. A system, comprising:
an electronic device having a component, at least one heat pipe associated with the component, a plurality of heat exchangers coupled to the at least one heat pipe, and a fan having a plurality of exhaust outlets oriented to exhaust air toward the plurality of heat exchangers.

2. The system as recited in claim 1, wherein the electronic device comprises a portable computer.

3. The system as recited in claim 1, wherein the electronic device comprises a notebook portable computer.

4. The system as recited in claim 1, wherein the component comprises a central processing unit (CPU).

5. The system as recited in claim 1, wherein the fan comprises a blower fan.

6. The system as recited in claim 1, wherein the at least one heat pipe comprises a single heat pipe coupled to the plurality of heat exchangers.

7. A cooling system, comprising:
a fan having a plurality of exhaust ports;
at least one heat exchanger disposed along the plurality of exhaust ports; and
a heat transfer member coupled to the at least one heat exchanger along the plurality of exhaust ports.

8. The cooling system as recited in claim 7, wherein the heat transfer member comprises at least one heat pipe.

9. The cooling system as recited in claim 7, further comprising a heat generating component associated with the heat transfer member.

10. The cooling system as recited in claim 7, further comprising a central processing unit (CPU) coupled to the heat transfer member.

11. The cooling system as recited in claim 7, wherein the fan comprises a generally flat blower fan having a housing with the plurality of exhaust ports.

12. The cooling system as recited in claim 7, wherein the at least one heat exchanger comprises a plurality of heat exchangers each having heat dissipation fins aligned with the direction of outflow at each of the plurality of exhaust ports.

13. A method for dissipating heat, comprising:
coupling at least one heat pipe to a heat exchanger system; and
positioning the heat exchanger system adjacent a plurality of fan exhaust outlets formed in a housing of a fan.

14. The method as recited in claim 13, wherein coupling comprises coupling the at least one heat pipe to a plurality of heat exchangers.

15. The method as recited in claim 13, further comprising engaging a component of an electronic device with the at least one heat pipe.

16. The method as recited in claim 15, wherein engaging comprises engaging a central processing unit (CPU) of the electronic device with the at least one heat pipe.

17. The method as recited in claim 15, wherein engaging comprises engaging the component of a notebook portable computer to the at least one heat pipe.

18. The method as recited in claim 13, wherein positioning comprises aligning a plurality of heat dissipation fins with the direction of air outflow at each of the plurality of exhaust outlets.

19. A system for dissipating heat, comprising:
means for transferring heat from a heat generating component in an electronic device to a fan; and
means for dissipating the heat at a plurality of fan exhaust outlets formed in a housing of the fan.

20. The system as recited in claim 19, wherein the means for transferring comprises at least one heat transfer means, or heat pipe means.

21. The system as recited in claim 19, wherein the means for dissipating comprises a plurality of heat exchanger means.
